(19) United States
(12) Patent Application Publication
(10) Pub. No.: US 2005/0112049 A1
(43) Pub. Date: May 26, 2005

(54) Methods of direct growth of carbon nanotubes on catalytic surfaces

(76) Inventor: William Hofmeister, Nashville, TN (US)

Correspondence Address: WADDEY & PATTERSON, 414 UNION STREET, SUITE 2020, BANK OF AMERICA PLAZA, NASHVILLE, TN, 37219, US

(21) Appl. No.: 10/495,198

(22) PCT Filed: Dec. 18, 2002
(86) PCT No.: PCT/US02/40553

Related U.S. Application Data
(60) Provisional application No. 60/342,265, filed on Dec. 18, 2001.

(51) Int. Cl. D01F 9/12; B05D 3/00

(52) U.S. Cl. 423/447.1; 427/299; 427/372.2

(57) ABSTRACT

The present invention uses a conductor as a catalytic support for carbon nanotube growth. The use of conductive catalytic support will provide a contact to the nanotubes with low resistance. Carbon nanotubes grown on insulators must be modified to allow good connections. Second, creation of catalytic particles has been largely accomplished by precipitation of transition metals from salt solutions or thermal decomposition of thin films, while the present method uses precipitation from a solid solution. This will allow better control of the size distribution of catalysts. The precipitates will be coherent with the support allowing good anchoring of the catalysts for base growth of carbon nanotubes. Third, the approach is amenable to patterning by photolithography or other means of applying copper/transition metal thin films.

### TECHNICAL FIELD

The present invention provides a method for synthesis of carbon nanotubes on an electrically conductive support, such as copper. More particularly, the present invention relates to synthesis of carbon nanotube transistors directly on a patternable support, suitable for ultra large scale integration (ULSI) patterning and interconnection.

### BACKGROUND ART

The 1999 International Technology Roadmap for Semiconductors (ITRS) identifies a pressing need “to investigate new devices that may provide a more cost-effective alternative to planar CMOS” in the next 10-15 years. This need derives from the well documented limitations of patterning and robust material synthesis technologies as device dimensions decrease below 100 nm. Carbon nanotube (CNT) transistors are a particularly promising alternative device technology. Recent work has demonstrated their efficacy as field-effect transistors, and the selective patterning of semiconducting CNTs. While little doubt now exists that CNT transistors will eventually provide superior functional performance to CMOS for many applications, considerable uncertainty remains regarding the ability to create practical alternative devices from CNT transistor circuits.

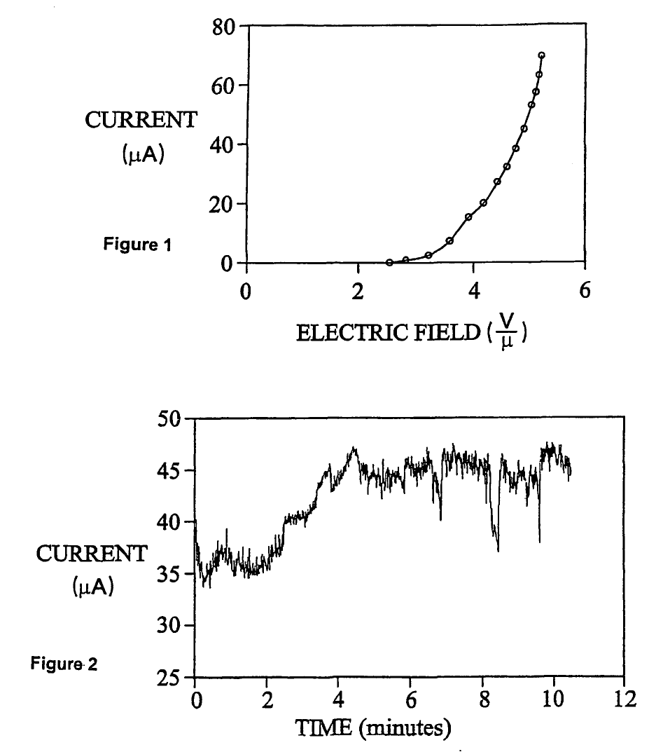

The field emission behavior of carbon nanotubes has been demonstrated by a number of groups. These materials present an excellent opportunity for construction of field emission devices. Small emission radii enhance efficient emission from carbon nanostructures; therefore, it is reasonable to assume that the emission behavior of nanotubes will also be enhanced by small diameters. Solid-state diffusion is a viable path to catalyst formation for CNT growth on copper surfaces. The emission behavior of these CNTs has been tested, and the results are shown in FIG. 1. The turn on voltage was reasonable at 3 Vμ⁻¹, however, the plot in FIG. 2 of emission current with time shows the present limitation of nanotube devices for field and thermionic emission. Currently, these structures lack the ability to emit stably over time. As shown in the data, periodically, the emission current decreases, presumably due to the degradation of the tube structure with time. This behavior is believed to be due to less than optimal coupling of the CNT to the substrate.

CNT growth by decomposition of hydrocarbons (e.g. chemical vapor deposition—CVD) requires a catalyst. Typically, these catalysts are nanocrystals of transition metals, metal oxides, or alloys. Because the CNT diameter is directly related to catalyst size, it is important to develop catalysts with small (<10 nm) and relatively uniform diameters. The most common support materials for these catalysts are oxides. However, for most electronic applications of carbon nanotubes, particularly for field and thermionic emitters, the tubes should directly contact a good electrical conductor.

As noted, nanocrystals of transition metals, metal oxides, or alloys are effective catalysts for CVD growth of CNTs. For example, Co:Mo catalysts have been used in the production of single-walled nanotubes (SWNT). A recent study involved these catalysts deposited from solution on SiO₂. Formation of aligned CNTs can be accomplished if the catalyst is properly distributed on a substrate. For aligned growth, anodically etched alumina, silicon, porous silicon, and zeolite substrates have been used with success. In these systems a mesoporous substrate is thought to provide a diffusion path for the carbon precursor, allowing base growth of the CNTs on the transition metal catalyst, provided the catalytic-support interaction is strong. The CNTs self-align during growth due to van der Waals attraction. The major disadvantage to these approaches is that the base support for the nanotube bundles is an insulator. While it may be possible to etch away insulating substrates and attach nanotube arrays to conducting substrates, such a methoding step increases the cost and complexity of the fabrication of nanotube devices.

The growth mechanism of nanotubes on supported catalysts has been the subject of considerable speculation. No clear mechanism has been proven. Molecular dynamics simulations have made inroads to the exact mechanism of growth. The diffusion of the reactive carbon source is thought to be a rate-limiting step. Surely, mesoporous substrates provide a clear diffusion path for reactants, and their success has led to the speculation that porous substrates are necessary. There is no evidence that other diffusion paths, such as surface diffusion, are inadequate.

One reason for the success of porous substrates is believed to be their ability to assist in the formation of the nanocrystalline catalysts. Transition metal salts are dried on the support surface, and, presumably, the variability of atomic sites on the support substrates assists in the nucleation of nanoparticles.

What is needed, therefore, is the ability to grow single and multiple nanotubes in particular locations on chips through a patterning scheme. Additionally, a new means of CNT synthesis directly on patternable metallic surfaces, suitable for ULSI patterning and interconnection is highly desirable.

The methods of the present invention answer such needs, by providing for direct CNT synthesis on a planar, patternable metallic surface. Such a capability could greatly enhance the functionality and cost-effectiveness of CNT devices. The route to nanocrystal formation is accomplished in the solid state, by precipitation. The size and distribution of these catalysts is controlled by solid-state diffusion. With this strategy, the size of the nanocrystalline precipitates can be controlled with careful experimentation.

### DISCLOSURE OF THE INVENTION

It is an object of the present invention to provide for the preparation of catalytic particles on a conducting substrate suitable for direct CNT synthesis.

It is another object of the present invention to provide for the preparation of a conducting substrate having catalytic particles having diameters less than about 10 nm distributed thereon.

It is a further object of the present invention to provide for the synthesis of single walled CNTs on metallic substrates by CVD.

It is yet another object of the present invention to provide for the functionalization of CNTs on metallic substrates.

Another object of the present invention is to prepare supported catalysts on a patternable conducting substrate.

It is still another object of the present invention to demonstrate patterning capabilities for a substrate and synthesized CNTs.

These and other objects are accomplished through novel methods using an electrical conductor for a catalytic support for CVD CNT growth, and preparation of catalytic particles from a solid solution instead of precipitation of transition metals from solution.

FIG. 1 is a plot of the emission behavior of CNTs grown on copper surfaces.

FIG. 2 is a plot of emission current with time for prior art CNTs grown on copper surfaces.

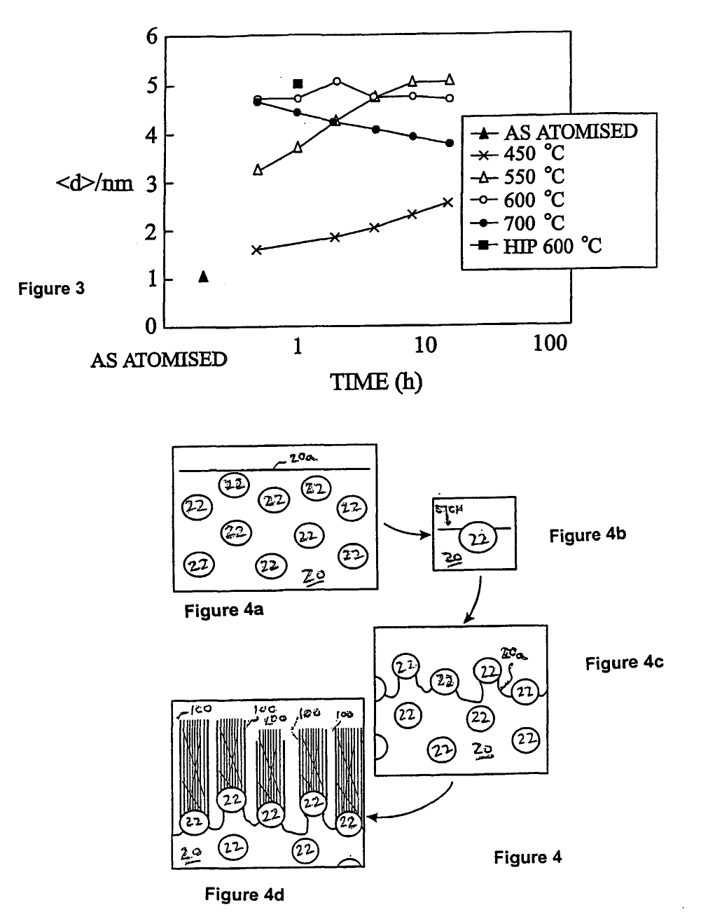

FIG. 3 is a graph of precipitate size calculated from magnetization data.

FIG. 4 is a schematic diagram of one embodiment of the method of the invention, and is composed of FIGS. 4a-4d which illustrate aspects of the inventive method.

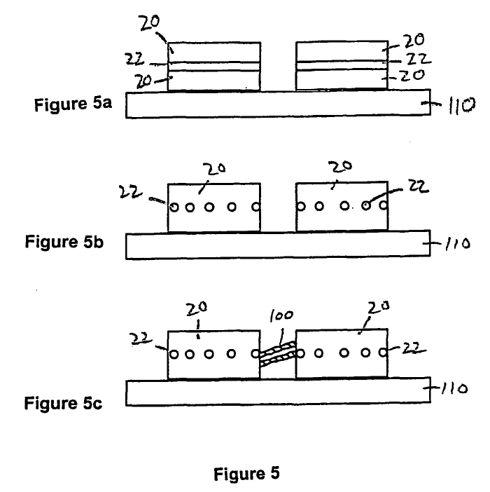

FIG. 5 is a schematic diagram of another embodiment of the method of the invention, and is composed of FIGS. 5a-5c which illustrate aspects of the inventive method.

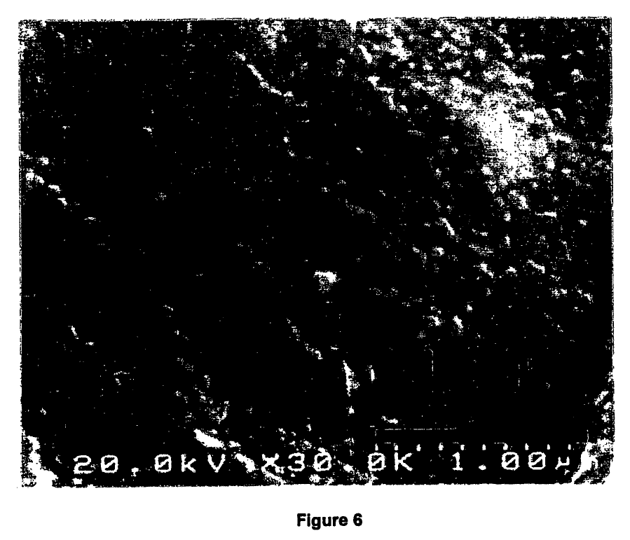

FIG. 6 provides is photomicrograph of a splat quenched CuCo alloy etched to reveal precipitates.

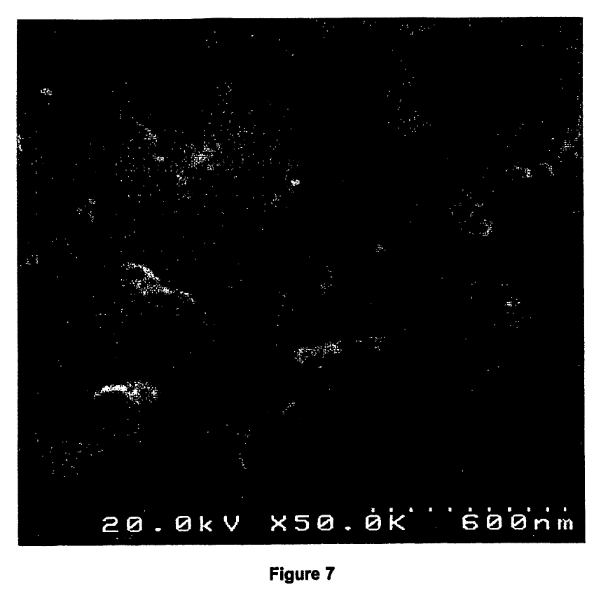

FIG. 7 is a photomicrograph of CNTs grown in accordance with an embodiment of the inventive method.

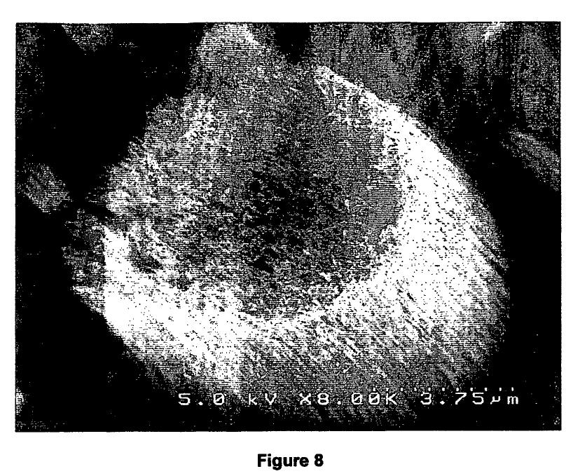

FIG. 8 is a photomicrograph of the CNTs prepared in accordance with the example.

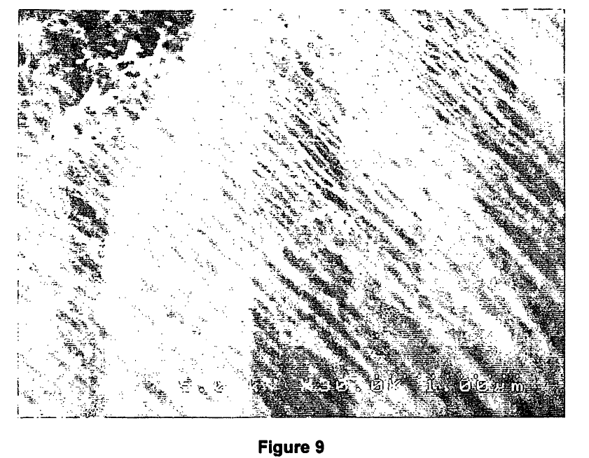

FIG. 9 is a photomicrograph of the CNTs prepared in accordance with the example.

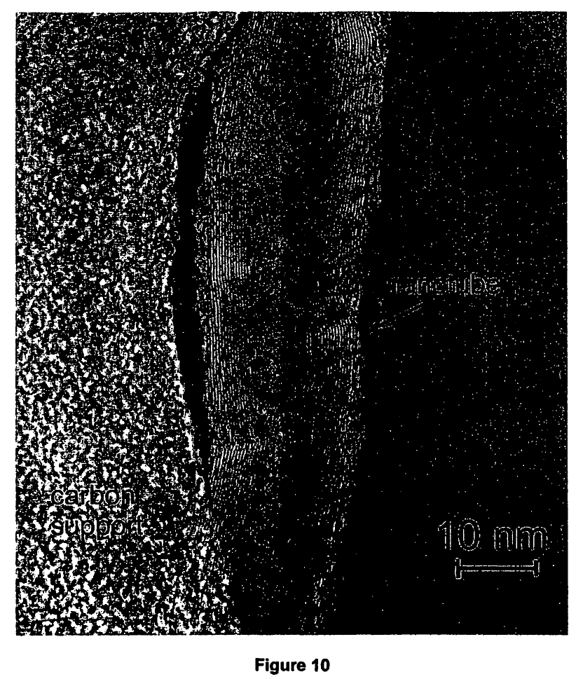

FIG. 10 is a photomicrograph of one of the CNTs of FIGS. 8 and 9, which has been imaged by transmission electron microscopy.

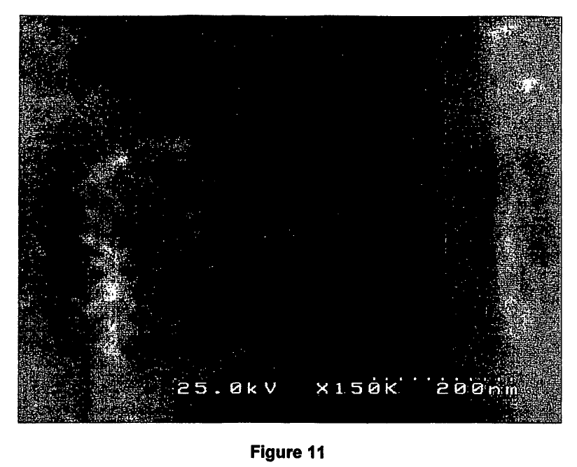

FIG. 11 is a photomicrograph of a CNT grown in accordance with the embodiment of the inventive method illustrated by FIG. 5.

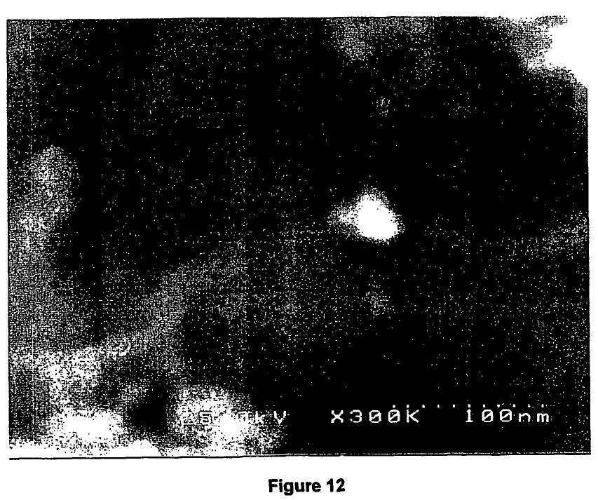

FIG. 12 is a photomicrograph of CNTs grown in accordance with the embodiment of the inventive method illustrated by FIG. 5.

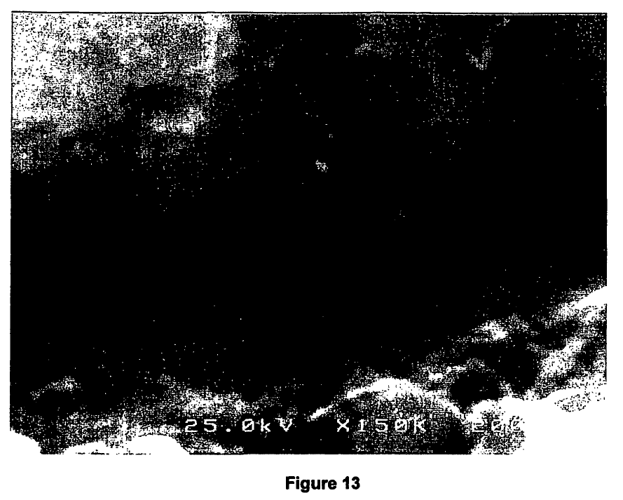

FIG. 13 is a photomicrograph of a CNT grown in accordance with the embodiment of the inventive method illustrated by FIG. 5.

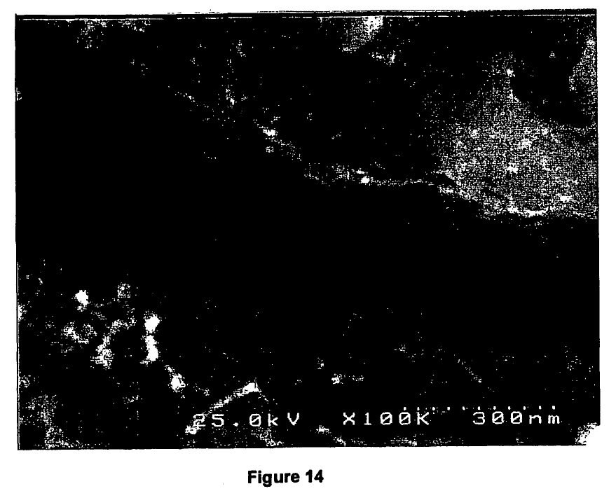

FIG. 14 is a photomicrograph of CNTs grown in accordance with the embodiment of the inventive method illustrated by FIG. 5.

### BEST MODE FOR CARRYING OUT THE INVENTION

The methods of this invention provide for the formation of nanotubes on non-porous substrates and mechanisms for the supply of active carbon to the base growth of nanotubes. In the present invention, the route to nanocrystal formation is accomplished in the solid state, by precipitation. The size and distribution of these catalysts is controlled by solid-state diffusion. With this strategy, the size of the nanocrystalline precipitates can be controlled with careful experimentation.

Nanotube growth is accomplished in one or two ways: either bulk growth or growth from multilayers. In bulk growth an alloy is prepared in “bulk” form by alloying during melting. The multilayer approach uses sputtering or electron beam or some other method of applying thin films to a substrate. The alloying elements are applied separately or together (co-deposited) on a substrate, given a thermal treatment, revealed, and used to grow nanotubes.

Bulk growth can be accomplished by preparing an alloy of at least about 0.5 atm % catalyst material for nanotube growth (such as a transition metal, an oxide or an alloy) in a balance of an electrical conductor, especially a metal (at least about 99.5 atm %). The upper limit of the presence of the catalyst material in the alloy corresponds to the solubility limit of the material in the metal, which can be as high as about 5 atm % at the eutectic temperature. The alloy can be quenched to form a solid solution and then catalyst particles precipitated by heat treatment to control the size and distribution of precipitates. Suitable alloys can be prepared, for instance, by “splat quenching” (such as wherein the samples are levitated in an induction coil, melted and caught between two copper platens) to prepare Cu—Co and Cu—Fe samples to make 100-150 micron thick foils, on which nanotubes are grown after the foils are heat-treated and etched. FIG. 6 provides a photomicrograph of a splat quenched CuCo alloy etched to reveal precipitates, and FIG. 7 provides a photomicrograph of CNTs grown in the described manner. In production, these alloys can be melt-spun into ribbons and used for nanotube catalysts and supports. Lower alloy concentrations can be made by melting and casting, solution heat-treating, and precipitation. Cold work, such as rolling or drawing, can be used to make sheets (and has the added benefit of breaking up larger precipitates). These sheets would be heat treated to gain the proper precipitate size, etched to reveal precipitates, and used to grow CNTs. The CNTs can be harvested by a mild nitric acid etch, and the substrate used again for CNT growth. In this case a reusable substrate is provided. Indeed, a belt of alloy material can be used to grow nanotubes in a continuous fashion, where the tubes are grown in a furnace, removed by light etching, and the belt recirculated to the furnace in a loop for more nanotube growth.

Multilayer growth is attractive because these layers can be patterned by photolithography, thus applying the catalyst in the desired location. This technique can be most advantageously practiced for single metal or alloy films. These films coalesce into crystalline catalysts as temperature is increased. In the inventive method, thin metallic layers (i.e., about 50-2000 nm) sandwich a thin (i.e., about 3-20 nm) catalyst layer. The metal provides a “cap” or medium that limits the diffusion of the catalyst layer and provides a more stable environment for the nucleation of smaller catalyst precipitates. This significantly reduces the catalyst size and narrows the size distribution. In fact, where the metal employed is copper and the catalyst cobalt, heat-treating a 100 nm Cu—15 nm Co—100 nm Cu film on a silicon wafer can produce Co particles less than 15 nm in diameter. After etching the layer (such as with 5 vol % HNO₃ in water), CNT can be grown by plasma enhanced chemical vapor deposition in a mixture of H₂ and CH₄ gas.

Generally, the precipitates are formed by a thermal treatment. This could be a cycle in a furnace, or exposure of the film or bulk alloy to a source of beam heating, such as laser or electron beam.

In addition to aqueous etching to reveal precipitates, the metal can be etched by reactive ion etching, plasma etching, or ion beam milling. In addition CuCoCu films can also be milled with a focused ion beam (FIB).

One goal of the patterning and ion beam milling is to create controlled directional growth of the nanotubes. If a nanotube can be grown from the edge of a layer, it might be possible to grow these structures across a gap in two electrodes, thus providing a means to create electronic structures such as transistors from carbon nanotubes. FIG. 5a-c provides a schematic illustration of CNT growth from layer interface where the catalyst 22, such as cobalt, is sandwiched between conductive layers 20, such as copper, on a suitable substrate 110. FIG. 5a. After heat treatment, the catalyst precipitates, FIG. 5b, after which CNTs 100 can be grown across the gap (FIG. 5c). Photomicrographs of CNTs grown in this manner are present as FIGS. 11-14.

Copper is the catalytic support of choice. An excellent electrical and thermal conductor, copper has a small or negligible solubility for some transition metals (e.g. Co, Fe, Nb, Mo, Zr and Cr). The Cu—CrNb system is most preferred to form precipitation-hardened copper alloys with good electrical and thermal conductivity. The CuCo system is also preferred because of the superior magneto resistance of nanosized cobalt precipitates in copper-rich alloys. The copper/transition metal systems contain metastable miscibility gaps, and spinodal decomposition is evident in undercooled liquids. For instance, in the copper-cobalt system the maximum solubility of Co in Cu is 5 atm %, and precipitation of Co in alloys containing up to 2 atm % Co has been achieved.

With rapid solidification techniques such as melt spinning, splat quenching, and atomization, it is possible to form solid solutions in Cu—5 atm % Co alloys. Precipitation is accomplished by heat treatment. From the magnetization data for these alloys, the mean particle size as a function of the time and temperature of heat treatment has been calculated. The measurements were verified by TEM. The results are shown in FIG. 3. In addition, the standard deviation in the particle size distribution is 1 nm for sizes less than 3 nm and less than 1.25 for mean particle sizes up to 6 nm. The critical radius (minimum stable size) of Co precipitates in Cu is one nm. Because a relationship exists between microhardness and particle size, it is possible with a simple Vickers hardness test to verify the size and volume fraction of precipitates. Another interesting finding is that the nanoparticles are coherent with the copper matrix. This finding is important in forming catalysts that are well connected to the support material.

Cu—Co solid solutions can be formed by several methods. First, foils are prepared in an electromagnetic levitation and splat quenching facility. Alloys are prepared, levitated and melted, and then double anvil quenched to thin (i.e., about 50-150 micron) foils approximately 5 cm in diameter. Homogeneous alloys of up to 10% Co can be prepared by rapid quenching. After heat treatment, the copper matrix is etched to reveal the nanocrystalline catalysts. A schematic of the method is shown in FIGS. 4a-4d, where the copper matrix 20 has cobalt particles 22 distributed therethrough; after etch (FIG. 4b), cobalt particles 22 become exposed on surface 20a of copper matrix 20 (FIG. 4c). Nanotubes 100 can then be grown from exposed cobalt particles 22 (FIG. 4d).

With proper etching, much of the catalyst should be attached to the copper matrix providing the support necessary to accomplish base growth of nanotubes. The roughness of the etch substrate should provide sufficient activity (or surface diffusion potential) to feed nanocrystalline growth.

A second method of preparation uses thin film deposition and surface alloying by laser melting. Thin films of Cu and the selected catalytic material are deposited on the substrate and alloyed by scanning a laser beam (or other suitable energy source) on the surface to melt and subsequently quench the surface layer. The advantage of this technique is the ability to pattern the active catalytic areas on a surface. Again, the nanoscale is achieved by solid-state precipitation. Additionally, homogeneous alloys can be applied by a “direct write” method from organic solutions. The solid solution is then annealed to form nanocrystalline precipitates, and etched to reveal the catalytic particles.

While one suitable material is Cu—Co, other alloying elements may be used. For example, the copper-niobium system has a similar phase diagram to copper-cobalt, and similar precipitation mechanisms. Ternary alloys such as Cu—Co—Fe and Cu—Co—Mo are also of relevance.

Catalyst substrate preparation, as described above, will comprise a large portion of the method. Once suitable substrates have been prepared, nanotube synthesis can occur via plasma enhanced chemical vapor deposition, simple chemical vapor deposition, flame synthesis, or other technique familiar to the skilled artisan. Once nanotube growth is achieved, the functional facets of the nanotubes can be verified through field emission experiments and I-V testing of nanotubes grown on patterned substrates.

Successful growth of carbon nanotubes on metallic substrates will open up an entirely new area of catalytic supports for carbon nanotube devices. Catalyst size and distribution can be well controlled by solid-state precipitation. Solid solutions of copper alloys can be formed by a number of methods on a variety of substrates.

The methods of the invention can be used for the cost-effective production of integrated CNT transistor devices. While the present invention focuses on the development of conductive catalytic substrates and basic CNT synthesis, future applications could involve functionalization of CNT transistor channels on a patternable interconnects.

Various embodiments of the present invention will be illustrated by reference to the following specific example. It will be understood, however, that such example is presented for purposes of illustration only and the present invention is in no way to be seen as limited thereby.

### EXAMPLE

A sample is prepared by successively sputtering 1000 angstroms of Cu, 150 angstroms of Co and another 1000 angstroms of Cu on a silicon substrate with native oxide coating. The wafer is heat treated at 450° C. for 40 minutes to form Co precipitates. The wafer is then etched in 5 vol. % HNO₃ in water to reveal the Co precipitates. CNTs are then grown on the surface of the wafer by plasma enhanced CVD. A photomicrograph of the CNTs is shown in FIGS. 8 and 9. These tubes have been imaged by transmission electron microscopy and an example of one of the tubes is shown in the photomicrograph of FIG. 10. The fringes from the walls of the nanotube are clearly visible.

The invention thus being described, it will be obvious that it may be varied in many ways. Such variations are not to be regarded as a departure from the spirit and scope of the present invention and all such modifications as would be obvious to one skilled in the art are intended to be included within the scope of the following claims.

1. A method of growing nanotubes, comprising preparing a combination of a catalyst material for nanotube growth and an electrical conductor, and making the catalyst material available for the growth of nanotubes thereon, and using the combination as a substrate for nanotube growth.

2. The method of claim 1 wherein the substrate is prepared for bulk nanotube growth or nanotube growth from multilayers.

3. The method of claim 2 wherein the substrate is prepared for bulk nanotube growth by alloying during melting.

4. The method of claim 3 wherein the substrate for bulk nanotube growth is provided by preparing an alloy of at least about 0.5 atm % catalyst material for nanotube growth in a balance of an electrical conductor.

5. The method of claim 4 wherein the catalyst material is selected from the group consisting of transition metals, oxides, or alloys.

6. The method of claim 5 wherein the catalyst material comprises cobalt.

7. The method of claim 4 wherein the electrical conductor comprises a metal.

8. The method of claim 7 wherein the metal comprises copper.

9. The method of claim 4 wherein the upper limit of the presence of the catalyst material in the alloy corresponds to the solubility limit of the catalyst material in the electrical conductor.

10. The method of claim 4 wherein the alloy is quenched to form a solid solution and then catalyst material is precipitated by heat treatment to control the size and distribution of precipitates.

11. The method of claim 2 wherein the substrate is prepared for multilayer nanotube growth by applying thin films of catalyst material and electrical conductor to a substrate.

12. The method of claim 11 wherein the catalyst material is selected from the group consisting of transition metals, oxides, or alloys.

13. The method of claim 12 wherein the catalyst material comprises cobalt.

14. The method of claim 11 wherein the electrical conductor comprises a metal.

15. The method of claim 14 wherein the metal comprises copper.

16. The method of claim 11 wherein the alloying elements are applied on a substrate, given a thermal treatment and the catalyst material revealed.

17. The method of claim 1 wherein nanotube growth is via chemical vapor deposition.

18. A substrate for the growth of nanotubes, the substrate comprising a combination of a catalyst material for nanotube growth and an electrical conductor, and making the catalyst material available for the growth of nanotubes thereon.

19. The substrate of claim 18 which is prepared for bulk nanotube growth or nanotube growth from multilayers.

20. The substrate of claim 19 which is prepared for bulk nanotube growth by alloying during melting.

21. The substrate of claim 20 which comprises an alloy of at least about 0.5 atm % catalyst material for nanotube growth in a balance of an electrical conductor.

22. The substrate of claim 21 wherein the catalyst material is selected from the group consisting of transition metals, oxides, or alloys.

23. The substrate of claim 22 wherein the catalyst material comprises cobalt.

24. The substrate of claim 21 wherein the electrical conductor comprises a metal.

25. The substrate of claim 24 wherein the metal comprises copper.

26. The substrate of claim 21 wherein the upper limit of the presence of the catalyst material in the alloy corresponds to the solubility limit of the catalyst material in the electrical conductor.

27. The substrate of claim 19 which comprises thin films of catalyst material and electrical conductor applied to a substrate.

28. The substrate of claim 27 wherein the catalyst material is selected from the group consisting of transition metals, oxides, or alloys.

29. The substrate of claim 28 wherein the catalyst material comprises cobalt.

30. The substrate of claim 29 wherein the electrical conductor comprises a metal.

31. The substrate of claim 30 wherein the metal comprises copper.

32. The substrate of claim 27 wherein the alloying elements are applied on a substrate, given a thermal treatment and the catalyst material revealed.
